(19) United States
(12) Patent Application Publication
(10) Pub. No.: US 2019/0047525 A1
(43) Pub. Date: Feb. 14, 2019

(54) SPRING BASED REGENERATIVE BRAKING SYSTEM

(71) Applicant: Ravi G. ATHALYE, Pune Maharashtra (IN)

(72) Inventor: Ravi G. ATHALYE, Pune Maharashtra (IN)

(21) Appl. No.: 16/076,875

(22) PCT Filed: Nov. 15, 2016
(86) PCT No.: PCT/IN2016/050399

§ 371 Date: Aug. 9, 2018

(30) Foreign Application Priority Data
Feb. 22, 2016 (IN) 201621006088

(51) Int. Cl. B60T 1/10; B62M 1/10; F16D 61/00; B62L 1/04; B62L 3/04

(52) U.S. Cl. CPC B60T 1/10; B62M 1/10; B60T 2270/60; B62L 1/04; B62L 3/04; F16D 61/00

(57) ABSTRACT

A spring based regenerative braking system is adapted to be mounted on a rear wheel of a vehicle comprises a handle assembly, a rear wheel assembly, a roller wheel assembly and a discharge level assembly that selectively operate in three modes namely a Synchronization mode, an Asynchronization mode and a Discharge mode for storing braking energy during braking events of the vehicle and efficient utilization and management thereof in stop and go traffic conditions.

### FIELD OF THE INVENTION

The present invention relates to a mechanism for regenerative braking of vehicles and more particularly to efficient management of stored braking energy.

### BACKGROUND OF INVENTION

The simplicity of pedaling and the ability to provide mechanical advantage through gears in response to a circular motion of the wheel has enabled the vehicles, such as bicycles, to be popularly used for transportation, exercise and recreation. Attempts are being made worldwide to creating cycle designs with the objectives to improving efficiency and reduction of pedaling effort.

Vehicles need to brake and accelerate in response to traffic conditions. It is well known that enormous energy/fuel is wasted in such Stop and Go traffic conditions that can be saved through an energy storage device that can capture the braking energy lost due to frequent braking during traffic conditions.

There are various attempts seen in the field of vehicles, particularly in the field of bicycles, wherein a battery is used as the energy storage device in order to enhance pedaling operations. However, such designs suffer from limitations of weight. Moreover, long charging time required for batteries of the order of hours makes the batteries incapable of storing energy particularly when available charging time is of the order of fractions of a second.

An elastic medium such as a spring can respond to a deforming force instantly and therefore making it ideal for storing and releasing energy instantly. Generally, traffic patterns require release of the stored energy in quick succession of storage. This results in a requirement of small capacity storage device but with quick charge and release capability. The spring meets this requirement efficiently.

Further, the prior art generally relates to mechanisms that reduce braking effort by using the bicycle momentum to augment the effort. For example, CN101367420A to Li Binghua et al. teaches a bicycle provided with clockwork spring strengtheners having a frame, a handle, wheels, a centre shaft and a flywheel. The bicycle is characterized by the pedal centre shaft with an energy storage and release device connected with the frame. While the bicycle is pedaled forward the reversely rotating centre shaft compresses the clockwork spring to exert force, the clock spring is released, so as to save force for driving. However, this invention does not use bicycle momentum to charge the spring.

There are few attempts seen in the art to utilize spring based regenerative braking systems. For example, U.S. Pat. No. 4,744,577 discloses a regenerative braking system that provides braking by transmitting the spring force of a deforming elastic medium as a torque tending to oppose the forward rotation of a wheel being braked. A brake pad assembly, mounted concentrically with the hub of a ground-engaging wheel, is actuated upon braking to provide frictional engagement between the hub and a wrapping mechanism which reels in a cable attached to an elastic medium, thereby deforming the elastic medium and storing energy, while applying a decelerating torque to the wheel. However said regenerative braking system is designed for low transmission torque of the order of elastic bands. The limitation comes from low area of contact of the friction brake that communicates the hub rotation to the planetary gears. The said regenerative braking system does not recognize the advent of low density high stiffness material like graphene. Thus to fully able to capture a substantial amount of energy it is imperative to have a spring as an energy storage medium and a clutch mechanism that handles the substantial torque with limiting clamping force. Moreover, said regenerative braking system fails to utilize tire surface to generate the increased torque transmission for greater energy capture. In addition, said regenerative braking system suffers from sudden increase in braking once the spring is fully coiled. Further, said regenerative braking system is incompetent to store energy through multiple braking episodes and release the accumulated energy at will in a single burst or in multiple releases at the will of the user.

Another example, U.S. Pat. No. 6,035,970 discloses an energy storage drive assembly provided for a bicycle that includes a coil spring mounted on the bicycle with at least one roller in abutment with a wheel of the bicycle. The energy storage drive assembly is adapted for storing energy on the spring in a first mode and further effecting the movement of the bicycle in a forward direction with the stored energy in a second mode. However, said energy storage device in the art transmits torque between the wheel and the energy storage spring through rotation of the cable. This mechanism has a strong limitation to the torque and has high energy losses. Further, the spring is mounted in front of the rider in said energy storage device that would be an encumbrance to normal use of the bicycle. A rear wheel mounted energy storage with a robust clutch for a pulsed energy transfer eliminates this inconvenience.

Another example, U.S. Pat. No. 6,053,830 provides spring-assist drive for a pedal-operated rider-propelled vehicle such as a bicycle which makes use of a wind-up coil spring mounted within the frame of the bicycle as auxiliary power. However, the spring-assist drive has a limitation that it requires the user to put additional effort in pedaling against the spring to store energy. Significantly, the spring-assist drive fails to have a provision for storing momentum of the bicycle.

Accordingly, there is a need for a spring based regenerative braking system adapted to be integrated with friction brakes of a vehicle for providing selective braking and acceleration thereof.

### SUMMARY OF THE INVENTION

The present invention provides a spring based regenerative braking system that is adapted to be mounted on a rear wheel of a vehicle for utilizing energy stored during braking instance of the vehicle. The spring based regenerative braking system comprises a handle assembly that includes at least one Brake lever, a brake cable, an Asynchronous lever and a plurality of connecting rods. The Brake lever works in a Synchronous mode. When operated, the Brake lever brakes the motion of the bicycle and when released, accelerates the vehicle with the energy recovered from braking. The person driving the vehicle can also add to the acceleration by pedaling simultaneous to when the brake is released. The Asynchronous lever operates to asynchronously release the energy with the operation of the brake lever.

The spring based regenerative braking system comprises a rear wheel assembly mounted along a central shaft of the rear wheel through a hub to which it is affixed to the rear wheel of the cycle. The hub is mounted on bearings that are mounted over a fixed central shaft. The cycle wheel is affixed to the hub. The hub is extended by a first sleeve thereby defining an extended hub whose length is sufficient to accommodate the spring cassette unit.

A second sleeve is mounted on the first sleeve riding over a one way rotating cam. The spring cassette unit is affixed over the second sleeve. The second sleeve is free to rotate in the direction opposite to the wheel rotation without impeding or influencing the wheel rotation. However, the second sleeve is locked to the first sleeve when rotating in the direction of the wheel only if the speed of rotation exceeds the speed of rotation of the first sleeve.

The spring cassette comprises of an outer casing and an inner casing between which is mounted the spiral of a clock spring which is positioned such that the outer end of said spring is affixed to the inner surface of the outer casing and the inner end of the spring is affixed to the outer surface of the inner casing. The inner casing is mounted in locked condition on the second sleeve.

A main drive sprocket is affixed on the second sleeve adjacent to the wheel. A discharge sprocket is affixed to the far end of the second sleeve. The spring cassette assembly is positioned between the main drive sprocket and the discharge sprocket. The discharge sprocket is attached to the outer casing through screws. The discharge sprocket has a centrally located hole that has a diameter greater than the diameter of the second sleeve. This facilitates frictionless movement of the discharge sprocket. A friction plate assembly is affixed to the fixed central shaft with its surface abutting to the face of the discharge sprocket. The Discharge sprocket is latched and arrested from rotation by a foot operated discharge lever. The friction plate assembly slows the rotation of the Discharge sprocket when it is discharging the stored energy without powering the vehicle. A nut mounted on the central axle can be adjusted to optimize the friction plate pressure on the discharge sprocket.

The spring based regenerative braking system includes a roller wheel assembly mounted on upper side of the rear wheel assembly and through a first chain connecting to the rear wheel assembly. The roller wheel assembly includes a first wheel subassembly and a second wheel subassembly. The first wheel subassembly includes a two drive sprockets connected through a first horizontal shaft to the fulcrum of roller wheel lever. The second wheel subassembly includes a second drive sprocket connected to a second brake friction roller along a second horizontal shaft using a circlip arrangement terminating on the extension of the roller lever. The second wheel subassembly includes a roller wheel ratchet that connects to the second brake friction roller. The roller wheel ratchet has a latch lever that connects to the roller wheel ratchet through a connecting arrangement that comprises a torsion spring. The latch lever has a latching arm that engages with the ratchet wheel of the second wheel assembly. The latch lever is configured to be actuated through the Async lever using a cable.

The spring based regenerative braking system includes a discharge assembly that includes a discharge lever. The discharge lever connects to a footrest. The discharge lever has a discharge port pin configured to be engaged with the discharge sprocket of the rear wheel assembly. The discharge assembly is mounted on a cycle frame through a discharge port hinge base, a discharge port hinge, a locking hinge and a locking spring.

### BRIEF DESCRIPTION OF THE DRAWINGS

FIG. 1 is a perspective view of a spring based regenerative braking system constructed in accordance with the present invention mounted on a rear wheel of a vehicle;

FIG. 1a is an exploded view of the spring based regenerative braking system of FIG. 1;

FIG. 2 is a perspective view of a roller wheel assembly and a rear wheel assembly mounted on a rear wheel of the vehicle;

FIG. 3 is a perspective view of the rear wheel assembly in accordance with FIG. 2;

FIG. 3a is an exploded view of the rear wheel assembly of FIG. 2;

FIG. 3b is a cross-sectional view of the rear wheel assembly of FIG. 3 taken along axis Z-Z;

FIG. 4 is a perspective view of the roller wheel assembly of FIG. 2;

FIG. 4a is an exploded view of the roller wheel assembly of FIG. 2;

FIG. 5 is a perspective view of a discharge assembly of the spring based regenerative braking system of FIG. 1; and

FIG. 5a is an exploded view of the discharge assembly of FIG. 5.

### DETAILED DESCRIPTION OF THE INVENTION

The invention described herein is explained using specific disclosures/mechanisms exemplary details for better understanding. However, the invention disclosed can be worked on by a person skilled in the art without the use of these specific disclosures.

References in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

References in the specification to “preferred embodiment” means that a particular feature, structure, characteristic, or function described in detail thereby omitting known constructions and functions for clear description of the present invention.

The present invention is illustrated with reference to the accompanying drawings, throughout which reference numbers indicate corresponding parts in the various figures. These reference numbers are shown in bracket in the following description.

In general aspect, the present invention discloses a spring based regenerative braking system adapted to be mounted on a rotating object, such as a rear wheel of the vehicle, for utilizing energy stored during braking instance of said rotating object. The spring based regenerative braking system enables energy of short interval braking incidences to be stored with high efficiency, wherein said system employs an energy saver spring to store the braking energy. The spring based regenerative braking system facilitates instantaneous storage and release of the braking energy thereby making it convenient to efficiently manage energy in stop and go traffic conditions, wherein the kinetic energy of the vehicle manifests as momentum that imparts force when it is forced to change. This is eventually used to deform the energy saver spring. It is understood here that the energy saver spring is configured to return to the natural state and release energy as momentum. The spring based regenerative braking system of the present invention converts momentum to elastic deformation and vice versa. The present invention facilitates storage of energy by pedaling which can be used as an additional torque when required.

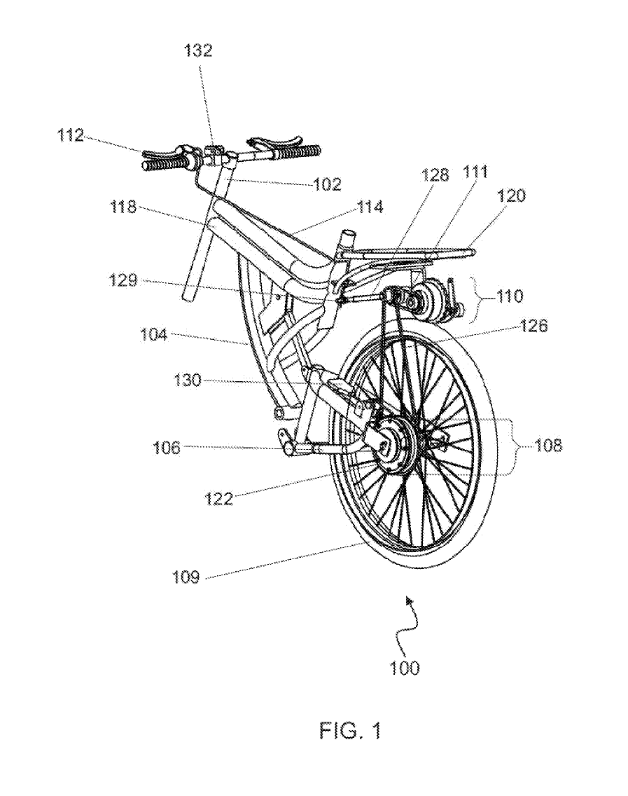

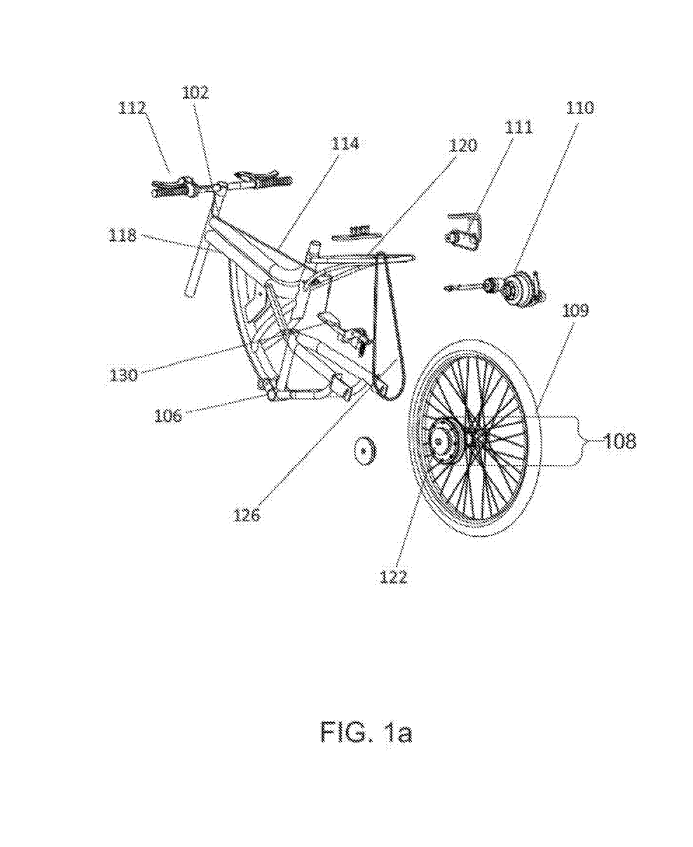

Referring to FIGS. 1-1a, the spring based regenerative braking system 100 in accordance with the present invention is shown. In this one preferred embodiment, the spring based regenerative braking system 100 is shown mounted on a bicycle. However, it is understood here that the spring based regenerative braking system 100 may be mounted on any other vehicle in other alternative embodiments of the present invention. The spring based regenerative braking system 100 comprises a handle assembly 102, a front supporting frame 104, a rear supporting frame 106, a rear wheel assembly 108 and a roller wheel assembly 110. In this one embodiment, the rear wheel assembly 108 preferably acts as an energy saver unit and the roller wheel assembly 110 acts as an energy transfer unit.

A first chain 126 passes over the roller wheel assembly 110 and the rear wheel assembly 108. The first chain 126 facilitates rotation connection between the roller wheel assembly 110 and rear wheel assembly 108, when braking function is performed causing energy saver spring to compress and coil. The roller wheel assembly 110 is provisioned with a roller shaft sprocket 416 that through chain 111 facilitates energy transfer while acting as a buffer mechanism for the roller wheel assembly 110 during said energy transfer. This is essential to isolate the tension of first chain 126 from the movement of a roller wheel lever 128. The handle assembly 102 includes at least one brake lever 112, a brake cable 114, an asynchronous (Async, hereinafter) lever 132 and a plurality of connecting rods 118.

The front supporting frame 104 includes a seat 120. The rear supporting frame 106 is attached to a rear wheel 109. The rear wheel assembly 108 includes a spring cassette unit 122 that is mounted preferably at a centre of the rear wheel 109 of the vehicle and on opposite side of the pedal chain sprocket. The roller wheel assembly 110 positions preferably on an upper side of the rear wheel assembly 108.

The roller wheel assembly 110 is configured to be operated by the brake lever 112 that is configured to be actuated through the brake cable 114. The brake cable 114 is connected to a roller wheel lever 128 through a pin 129, preferably positioned on the front supporting frame 104. A discharge assembly 130 is connected to the roller wheel assembly 110 as illustrated. The Async lever 132 is positioned on the handle assembly 102.

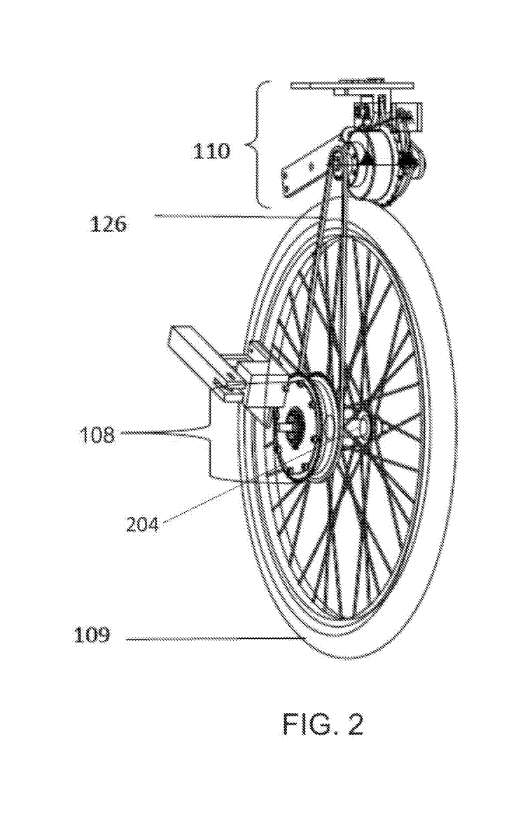

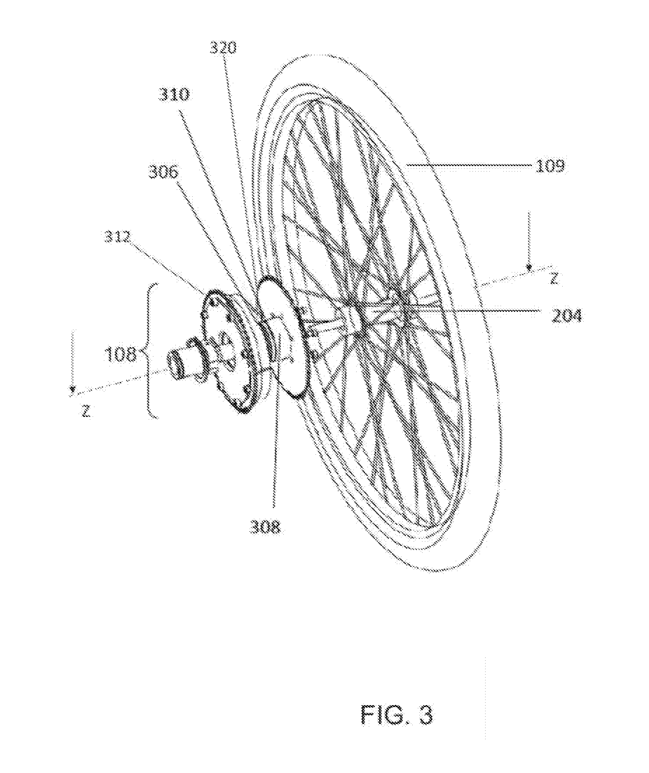

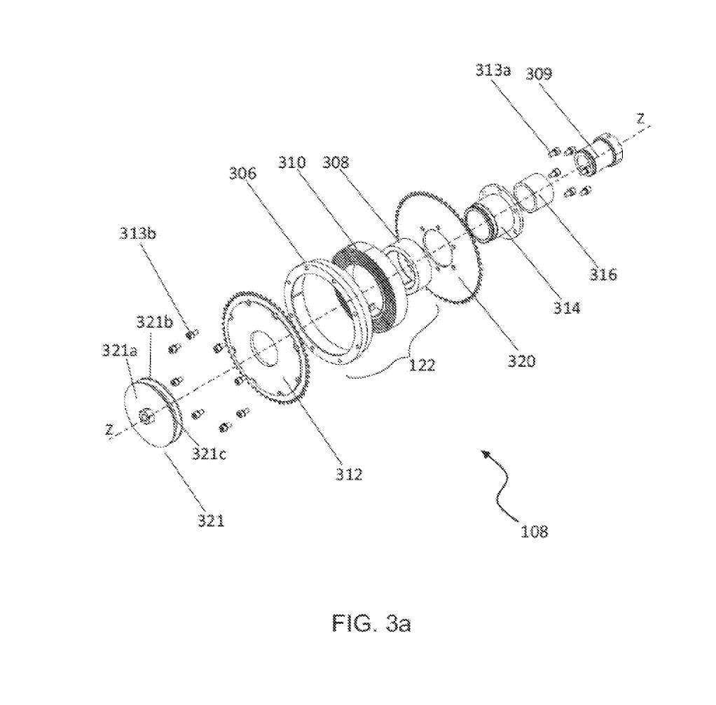

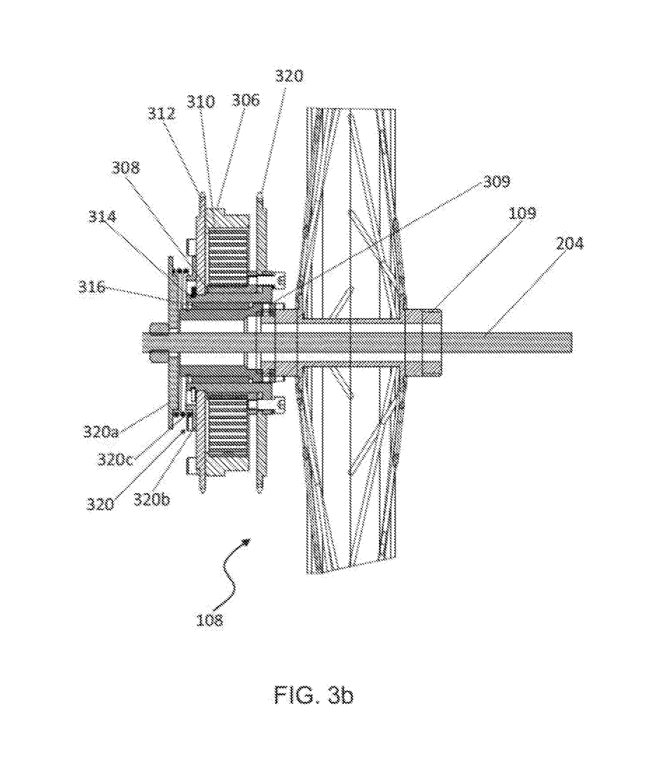

Referring to FIGS. 2-3, the roller wheel assembly 110 and rear wheel assembly 108 are preferably positioned in proximity to the rear wheel 109. The rear wheel assembly 108 is fixed on the rear wheel 109 such that the spring cassette unit 122 is mounted on the second sleeve 314 over the central shaft 204. The first chain 126 establishes rotational connection between the roller wheel assembly 110 and rear wheel assembly 108.

As shown in FIGS. 3-3a, the rear wheel assembly 108 is shown with the spring cassette unit 122. The spring cassette unit 122 comprises an outer casing 306, an inner casing 308 and an energy saver spring 310 that are concentrically positioned along a horizontal axis-Z. An outer end of the energy saver spring 310 is brazed to an inner surface of outer casing 306. It is understood here that the energy saver spring 310 is configured to be wound in an anticlockwise direction, while being positioned on the inner casing 308. The outer casing 306 positions on the energy saver spring 310 such that the energy saver spring 310 is sandwiched between the inner and outer casings 306, 308.

Referring to FIGS. 3a-3b, the rear wheel assembly 108 includes an extended hub or a wheel mounting hub 309. The extended hub 309 is composed of first sleeve whose length is sufficient to accommodate the spring cassette assembly. A second sleeve 314 is mounted on the first sleeve riding over a one way rotating cam 316. The second sleeve 314 is free to rotate in the direction opposite to the wheel rotation without impeding or influencing the wheel rotation. However, the second sleeve 314 is locked to the first sleeve of the extended hub 309 when rotating in the direction of the wheel 109 only if the speed of rotation exceeds the speed of rotation of the first sleeve of the extended hub 309. The second sleeve 314 receives inner casing 308 of the spring cassette unit 122 thereon.

A main drive sprocket 320 is screwed onto the second sleeve 314 adjacent to the rear wheel 109 by using a plurality of first connecting members 313a. A discharge sprocket 312 is positioned besides the outer casing 306 of the spring cassette unit 122 through a plurality of second connecting members 313b and affixed to the far end of the second sleeve 314. The discharge sprocket 312 has a centrally located hole that has a diameter greater than the diameter of the second sleeve 314. This facilitates frictionless movement of the discharge sprocket 312. The first and second connecting members 313a, 313b are preferably selected from spring washers, machine washers, socket head cap screws and the like.

The rear wheel assembly 108 includes a friction plate assembly 321. The friction plate assembly 321 is affixed to the fixed central shaft with its surface abutting to the face of the discharge sprocket 312. In this one embodiment, the friction plate assembly 321 includes a first friction plate 321a and a second friction plate 321b such that a friction plate spring 321c is brazed between the first and second friction plates 321a, 321b. The pressure exerted by the friction plate assembly 321 to the face of the Discharge sprocket 312 is adjustable through tightening of the nut on the central shaft.

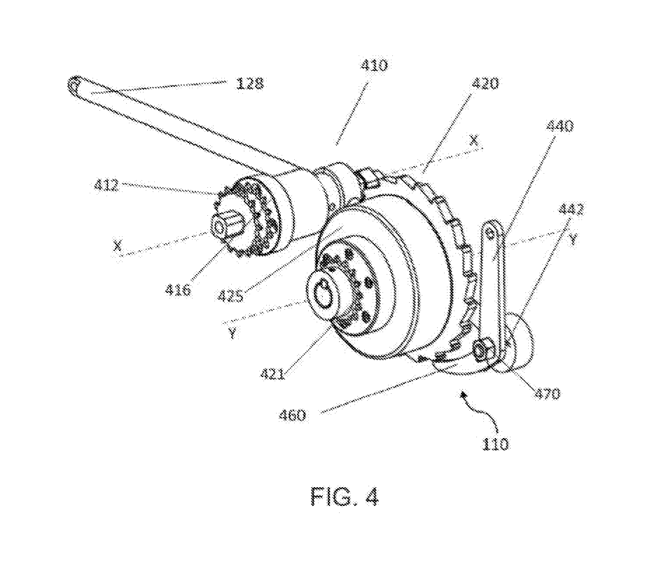

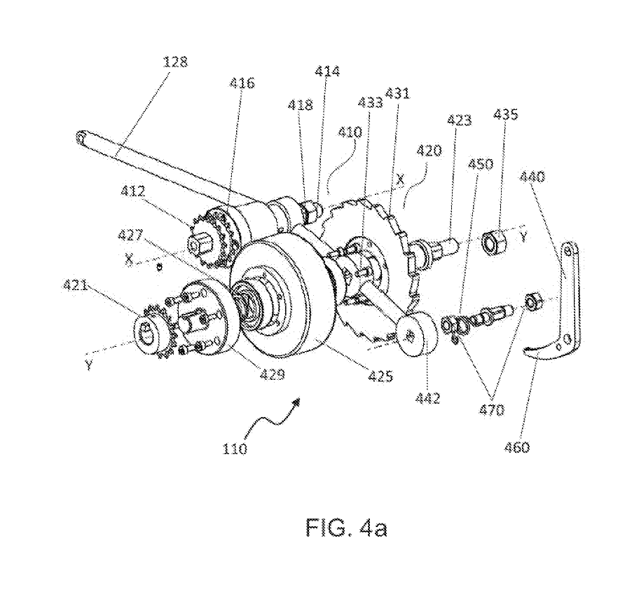

Referring to FIG. 4, the roller wheel assembly 110 includes a first wheel subassembly 410 and a second wheel subassembly 420. The first wheel subassembly 410 is concentrically positioned along a central axis-X. The second wheel subassembly 420 is concentrically positioned along a central axis-Y. The first and second wheel subassemblies 410, 420 are positioned such that the central axis-X is parallel to the central axis-Y.

Referring to FIG. 4a, the first wheel subassembly 410 includes a two drive sprocket 412 connected through a first horizontal shaft 414 at a fulcrum of the roller wheel lever 128. A first brake roller sprocket 416 and the two drive sprocket 412 are mounted on the first horizontal shaft 414 adjacent to each other. It is understood here that the first horizontal shaft 414 is mounted at the fulcrum of the roller wheel lever 128 and accordingly the roller wheel assembly 410 is affixed to the frame of the vehicle at the fulcrum of the roller wheel lever 128. The first wheel subassembly 410 is held in position through a first hexagonal lock nut 418.

The second wheel subassembly 420 includes a second drive sprocket 421 connected to a second brake friction roller 425 along a second horizontal shaft 423 using a circlip arrangement 427 terminating on the extension of the roller wheel lever 128. It is understood here that the second horizontal shaft 423 is mounted at the far end of the roller wheel lever 128 but substantially parallel to the first horizontal shaft 414.

The second drive sprocket 421 is connected to the first brake roller sprocket 416 through the second chain 111. The second chain 111 transmits torque generated on the second drive sprocket 421 on to the first brake roller sprocket 416 during the braking function. The circlip arrangement 427 with a drive sprocket holder 429 connects to the second brake friction roller 425 through a plurality of connecting members such as screws. The connecting members engage with a respective plurality of openings defined along a first sidewall of the second brake friction roller 425. The second wheel subassembly 420 includes a roller wheel ratchet 431 that connects to the second brake friction roller 425 along a second sidewall of the second brake friction roller 425 thereby using a plurality of socket head cap screws 433. The second wheel subassembly 420 is held in position through a second hexagonal lock nut 435 that connects to the second horizontal shaft 423.

Now referring to FIGS. 4-4a, the roller wheel lever 128 is connected to a latch lever 440 along a connecting post 442 through a connecting arrangement that comprises a torsion spring 450 and a hexagonal nut 470. The latch lever 440 has a latching arm 460 connected at a distal end thereof. The latch lever 440 engages with the roller wheel ratchet 431 in this one embodiment. The latch lever 440 is configured to be actuated through the Async lever 132 that is operated through the brake cable 114.

It is understood here that the first wheel subassembly 410 and the second wheel subassembly 420 are connected to the roller wheel lever 128 such that the roller wheel lever 128 when operated through a hand brake of the vehicle causes the second brake friction roller 425 to contact the rear wheel 109. The second brake friction roller 425 and the rear wheel 109 are aligned to physically contact each other such that the second brake friction roller 425 achieves the same tangential velocity as that of the rear wheel 109 and eventually transmits the tangential velocity to the first brake roller sprocket 416 through the second chain 111. The first brake roller sprocket 416 and the second brake friction roller 425 rotate in a direction that is opposite to the direction of rotation of the rear wheel 109.

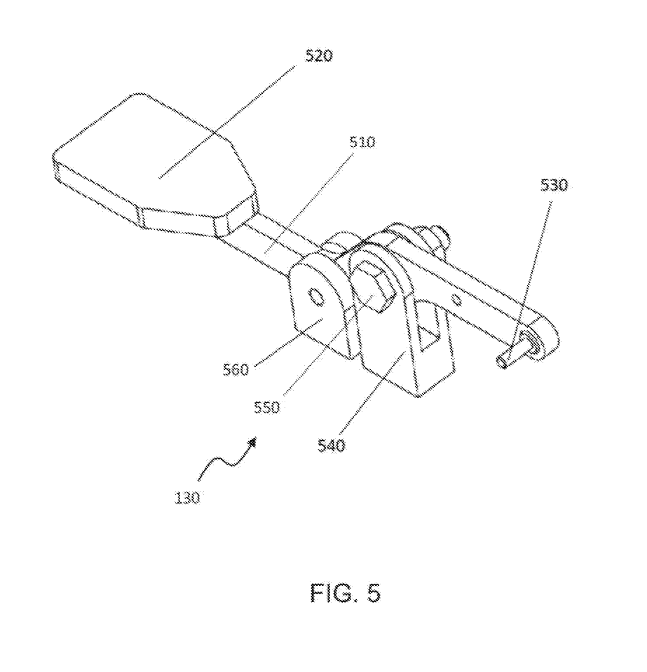

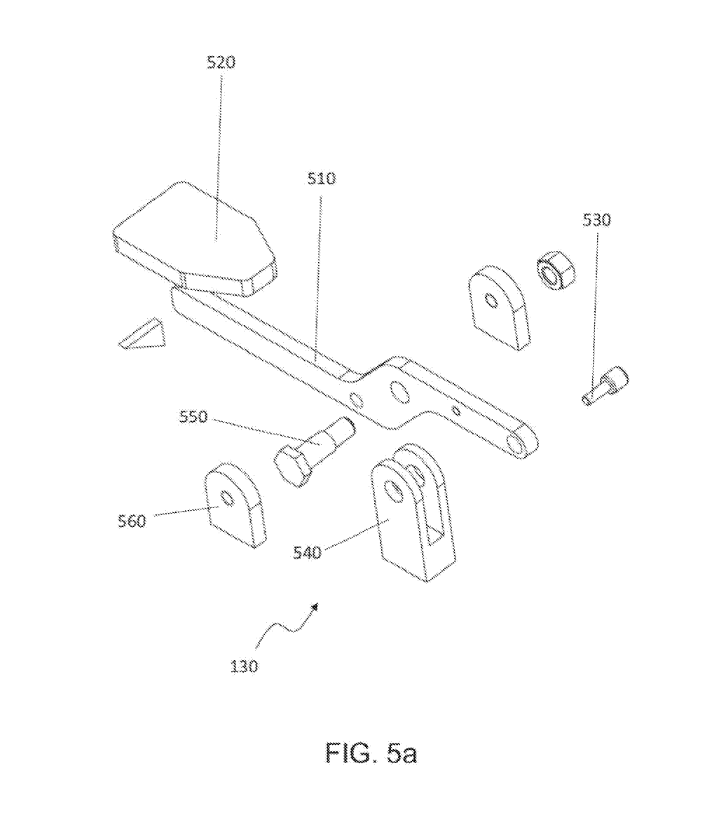

As shown in FIGS. 3a and 5-5a, the discharge assembly 130 includes a discharge lever 510 that connects to a footrest 520. In this one embodiment, the footrest 520 is welded to the discharge lever 510. However, it is understood that the footrest 520 may be connected to the discharge lever 510 by other connecting mechanisms known in the art. The discharge lever 130 includes a discharge port pin 530 that engages with the discharge sprocket 312. The discharge assembly 130 positions over the frame 106 such that the discharge port pin 530 engages with the discharge sprocket 312. The discharge assembly 130 includes a discharge port hinge base 540 that is welded on the frame 106. A discharge port hinge 550 is preferably inserted through the discharged port hinge base 540 and held in position using a washer and a locknut arrangement. A locking hinge 560 is added on either sides of the discharge lever 510 and held in position on the frame 106 using a spring loaded grub screw. A balancing spring (not shown) is fixed between the frame 106 and discharge lever 130 thereby ensuring that said spring is always in tension during operation thereof.

Referring to FIGS. 1-5a, an assembly procedure of the spring based regenerative braking system 100 is described hereinafter:

In an initial step, the rear wheel assembly 108 including the spring cassette unit 122 is mounted on the shaft 204 of the rear wheel 109. In this step, a drive chain of the vehicle is properly aligned and the wheel 109 is balanced accordingly. In this step, the discharge sprocket 312 of the rear wheel assembly 108 is connected to the sprocket 412 of the roller wheel assembly 110 through the first chain 126. The first chain 126 facilitates the roller wheel assembly 110 to rotate and charge the energy saver spring 310 in the direction opposite to the rotation of the wheel 109.

In next step, the roller wheel assembly 110, including the first wheel sub assembly 410 and the second wheel sub assembly 420, is mounted on the frame 106. In further step, the roller wheel lever 128 is connected the frame 106. It is understood here that the roller wheel assembly 110 includes a hinge block that is welded to the carriage of the vehicle thereby ensuring that said hinge block is concentric to a hole on the brake lever 112. In next step, a hinge pin is inserted in the hinge block followed by tightening using the machine washer, spring washer and lock nut. In next step, a cable holder is fixed on the brake lever 112 using a plurality of Socket Head Cap Screws. In further step, the cable 114 is passed through the cable holder and attached to the latch lever 440 in order to actuate the latching arm 460 through the cable 114. In next step, a frame mount is welded on the frame in a predefined orientation thereby using a first pin, preferably hexagonal headed screw, through which the cable 114 is passed. In next step, a second pin, preferably socket head cap screw, is inserted in the brake lever 112 and subsequently the cable 114 is fixed therein using a machine washer and a locknut arrangement. In further step, the discharge assembly 130 is positioned on the frame 106 such that the discharge port pin 530 is engaged with the discharge sprocket 312. In next step, the discharge assembly 130 is held in place thereby mounting locking hinge 560, discharge port hinge 550 and the balancing spring in predefined position.

Now referring to FIGS. 1-5a, a braking and an acceleration cycle facilitated by the spring based regenerative braking system 100 is described hereinafter:

The latch lever 440 operated through Async lever 132 is a single directional pawl that enables the energy saver spring 310 to coil without exerting any torque on the rear wheel 109. However, the resistance of the energy saver spring 310 is transmitted to the roller wheel assembly 110 which in turn transfers the resistance to the rear wheel 109 thereby causing the braking action. The braking torque of the energy saver spring 310 exists till the energy saver spring 310 is completely coiled. Thereafter, the energy saver spring 310 gets locked thereby causing a step change in the braking torque. In the released condition of the hand brake 112, the roller wheel assembly 110 separates from the rear wheel 109 which in turn release the force on the energy saver spring 310. Accordingly, the energy saver spring 310 gets uncoiled to exert elastic force through the one way cam 316 on the rear wheel hub. It is understood here that the energy saver spring 310 uncoils in the same direction as that of the forward rotation of the vehicle. Once the energy saver spring 310 is uncoiled, one way cam 316 releases influence on the rear wheel hub 109A thereby allowing the vehicle to continue rotation without interference of the energy saver spring 310.

Again referring to FIGS. 1-5a, the spring based regenerative braking system 100 preferably operates in at least three operational modes namely a Synchronous mode, an Asynchronous mode and a Discharge mode respectively operated through Sync Lever 112, Async Lever 132 and Discharge lever 130 in a manner described hereinafter:

In the Synchronous mode, the vehicle is in motion along with a commensurate momentum relative to the total moving mass. For the Synchronous mode function, the Async Lever 132 is in first position. The Sync Lever 112 is a spring return brake lever that through gripping and release of the lever causes braking and acceleration of the vehicle.

In this mode, the brake lever 112 on the handle of the vehicle is gripped and compressed to cause the braking function. The braking function of brake lever 112 activates the roller wheel assembly 110 that allows the roller wheel assembly 110 to contact the rear wheel 109 thereby attaining the same tangential velocity as that of the rear wheel 109. The roller wheel assembly 110 is connected to the free end of the energy saver spring 310 through the first chain 126. Accordingly, the energy saver spring 310 coils and communicates elastic force to the rear wheel 109 thereby causing the braking action.

When the brake lever 112 is released the roller wheel assembly 110 disengages with the rear wheel 109. In the released condition of the brake lever 112, the rear wheel hub is powered by the energy saver spring 310 that accelerates the vehicle until the energy saver spring 310 gets fully uncoiled. It is understood here that the level of acceleration is determined by the number of turns of the energy saver spring 310 and material characteristics of the spring cassette unit 122.

In the Synchronous mode, the one way rotating cam 316, mounted between the rear wheel hub and the second sleeve 314, enables the energy saver spring 310 to charge without influencing the rear wheel 109. The energy saver spring 310 uncoils in opposite direction to the charging rotation to power the rear wheel 109 through the action of one way clutch. The one way cam 316 disengages from the rear wheel 109 in the discharged condition of the energy saver spring 310 such that the free end stops rotating and allows the vehicle to coast without the influence of the energy saver spring 310.

In the Asynchronous mode, the vehicle is in motion and has commensurate momentum. The brake lever 112 on the handle of the vehicle is gripped and compressed to cause the braking function. The braking function of brake lever 112 activates the roller wheel assembly 110 that allows the roller wheel assembly 110 to contact the rear wheel 109 thereby attaining the same tangential velocity as that of the rear wheel 109. The roller wheel assembly 110 is connected to the free end of the energy saver spring 310 through the first chain 126. Accordingly, the energy saver spring 310 coils and communicates elastic force thereof to the rear wheel 109 thereby causing braking action. However, the roller wheel assembly 110 is arrested from reversed rotation by the latched condition of the roller wheel ratchet 431 when the brake lever 112 is released. This arrests the rotation of the energy saver spring 310.

In the Asynchronous mode, the Async lever 132 can be moved from the first position to a second position such that the roller wheel assembly 110 is unlatched to facilitate the energy saver spring 310 to power the rear wheel hub in order to cause acceleration. In the Asynchronous mode, the one way cam 316, mounted between the rear wheel hub and the second sleeve 314, allows the rear wheel 109 to rotate without engaging the energy saver spring 310. However, the energy saver spring 310 remains in the coiled position such that the vehicle is prohibited from accelerating as a consequence of the released condition of the brake lever 112. In this mode, the brake lever 112 decelerates the vehicle however cannot release the energy stored by returning the brake lever 112 to the original state.

In the Discharge mode, the Async lever 132 is in the second position and the energy saver spring is 310 is in a charged condition with energy stored in a coiled state. In this mode, the footrest 520 is momentarily depressed such that the discharge lever 130 unlatches the discharge sprocket 312 through the latch lever 440/460. In this mode, the energy saver spring 310 is unwound without influencing the rear wheel hub of the rear wheel 109. In this mode, the vehicle is rendered safe for parking. Thus, the Discharge mode prevents an unsafe condition arising from parking of the vehicle in the Asynchronous mode wherein the energy of the energy saver spring 310 is discharged without powering the vehicle.

In the context of the present invention, various alternative embodiments of the spring based regenerative braking system 100 are described hereinafter:

In an alternative embodiment of the present invention, the spring based regenerative braking system 100 may include a flared rim of the bicycle that enables the roller wheel assembly 110 to contact the metal rim which is free from road contamination. In this one alternative embodiment, the roller wheels are mounted on common axis that contacts the flared rim edges of the rear wheel 109.

In an alternative embodiment of the present invention, the spring based regenerative braking system 100 may utilize a hollow axle cavity type rear wheel 109. In this one embodiment, the rear wheel 109 enables the energy saver spring 310 to be placed in a position that is central to the rear wheel 109 in order to minimize the imbalance in weight on the frame 106. This allows only the main drive sprocket 320 and discharge sprocket 312 to be on singe side of the frame. This off-centered weight can be balanced by the weight of the roller wheel lever 128 positioned on the other side of the frame 106.

In an alternative embodiment of the present invention, the spring based regenerative braking system 100 may be implemented on the electric bicycles to extend range by conserving braking energy for small interval braking events.

In an alternative embodiment of the present invention, the spring based regenerative braking system 100 may be implemented on locomotive wheels to provide acceleration traction and torque for energy efficiency and high and multiple wheel traction acceleration.

In an alternative embodiment of the present invention, the spring based regenerative braking system 100 may be implemented on elevators for energy savings and utilization thereof occurring from braking instances.

In an alternative embodiment of the present invention, the spring based regenerative braking system 100 may be utilized in minimizing HT motor starting time reducing impact of voltage fluctuation due to highly inductive load on the power system during start up.

The foregoing description of specific embodiments of the present invention has been presented for purposes of illustration and description. They are not intended to be exhaustive or to limit the present invention to the precise forms disclosed, and obviously many modifications and variations are possible in light of the above teaching.

The embodiments were chosen and described in order to best explain the principles of the present invention and its practical application, to thereby enable others, skilled in the art to best utilize the present invention and various embodiments with various modifications as are suited to the particular use contemplated.

It is understood that various omission and substitutions of equivalents are contemplated as circumstance may suggest or render expedient, but such are intended to cover the application or implementation without departing from the spirit or scope of the present invention.

1. A spring based regenerative braking system mounted on a rear wheel of a vehicle for utilizing energy stored during braking instances thereof, the spring based regenerative braking system comprising:
a handle assembly having at least one brake lever, a brake cable, an asynchronous lever, an associated cable and a plurality of connecting rods;
a rear wheel assembly mounted along a sleeve mounted over a one way cam which is mounted on a hub over the central shaft of the rear wheel, the sleeve moving freely in rotation opposite to rotation of the wheel thereby locking the hub when rotating in the same direction as that of wheel, the rear wheel assembly having at least one spring cassette unit formed out of an inner casing, an outer casing and an energy saver spring, the energy saver spring configured to be uncoiled in a predefined direction during braking of the vehicle, the outer casing positioned with a discharge sprocket and a main drive sprocket on respective sides of vehicle frame and the rear wheel assembly;
a friction plate assembly positioned adjacent to the discharge sprocket along the central axis;
a roller wheel assembly connected to the rear wheel assembly through a first chain, the roller wheel assembly having a first wheel subassembly and a second wheel subassembly interconnected through a second chain, the first wheel subassembly having a two drive sprocket connected to a first brake roller sprocket along a first horizontal shaft, the second wheel subassembly having a second drive sprocket connected to a second brake friction roller along a second horizontal shaft through a circlip arrangement terminating on extension of the roller wheel lever, the second wheel subassembly having a roller wheel lever connected to the second brake friction roller, the roller wheel ratchet having a latch lever, the latch lever engaging with the roller wheel ratchet through a latching arm thereof; and
a discharge assembly having a discharge lever connected to a footrest attached thereto, the discharge lever having a discharge port pin engaged with the discharge sprocket of the rear wheel assembly,
wherein the spring based regenerative braking system facilitating a Synchronous mode, an Asynchronous mode and a Discharge mode during utilization thereof.

2. The spring based regenerative system as claimed in claim 1, wherein the first horizontal shaft is mounted at a fulcrum of the roller wheel lever.

3. The spring based regenerative system as claimed in claim 1, wherein the roller wheel assembly is affixed to the vehicle frame at the fulcrum of roller wheel lever.

4. The spring based regenerative system as claimed in claim 1, wherein the second shaft of the second sub assembly is mounted at the far end of the roller wheel lever but substantially parallel to the first horizontal shaft.

5. The spring based regenerative braking system as claimed in claim 1, wherein the rear wheel assembly acts as an energy saver unit.

6. The spring based regenerative braking system as claimed in claim 1, wherein the roller wheel assembly acts as an energy transfer unit.

7. The spring based regenerative braking system as claimed in claim 1, wherein the energy saver spring coils up in a direction opposite to a forward motion of the wheel.

8. The spring based regenerative braking system as claimed in claim 1, wherein the rear wheel assembly is assembled such that the hub of the wheel is mounted over the non rotating central shaft through a plurality of bearings followed by mounting of the sleeve over the hub of the wheel through a one directional rotating bearings followed by mounting of the sprocket over the sleeve adjacent to the wheel followed by mounting of the spring cassette unit adjacent to a sprocket on the far end to the wheel and a second sprocket mounted adjacent to the spring cassette on the far end to the first sprocket.

9. The spring based regenerative braking system as claimed in claim 1, wherein the friction plate assembly includes a first friction plate, a second friction plate and a spring brazed therebetween and mounted over a non rotating shaft adjacent to the first friction plate along with a nut.

10. The spring based regenerative braking system as claimed in claim 1, wherein the first horizontal shaft is parallel to the second horizontal shaft.

11. The spring based regenerative braking system as claimed in claim 1, wherein the latch lever is configured to be actuated through a two position lever thereby using a connecting arrangement.

12. The spring based regenerative braking system as claimed in claim 1, wherein the discharge assembly is mounted on a cycle frame through a discharge port hinge base, a discharge port hinge, a locking hinge and a balancing spring.

13. The spring based regenerative braking system as claimed in claim 1, wherein the Synchronous mode facilitates braking during a gripped and compressed condition of the brake lever.

14. The spring based regenerative braking system as claimed in claim 1, wherein the Synchronous mode facilitates acceleration during a released condition of the brake lever.

15. The spring based regenerative braking system as claimed in claim 1, wherein the Synchronous mode is such that an extent of acceleration is determined by number of turns of the energy saver spring.

16. The spring based regenerative braking system as claimed in claim 1, wherein the Asynchronous mode facilitates storage of energy in the energy saver spring without being released through the brake lever.

17. The spring based regenerative braking system as claimed in claim 1, wherein the Asynchronous mode facilitates deceleration of the vehicle without releasing the stored energy when returning the brake lever to original state.

18. The spring based regenerative braking system as claimed in claim 1, wherein the Discharge mode facilitates discharging of the energy stored in the energy saver spring without powering the rear wheel.

19. The spring based regenerative braking system as claimed in claim 1, wherein the energy saving spring assists acceleration when angular speed of the wheel is slower than the angular speed of the uncoiling of the spring.

20. The spring based regenerative braking system as claimed in claim 1, wherein the energy saving spring releases influencing the wheel when it is completely uncoiled.
